(19) United States
(12) Patent Application Publication
(10) Pub. No.: US 2006/0150108 A1
(43) Pub. Date: Jul. 6, 2006

(54) INFORMATION PROCESSING DEVICE, INFORMATION PROCESSING METHOD, STORAGE MEDIUM, AND PROGRAM

(75) Inventors: KEIJI ADACHI, Kawasaki-shi (JP); Shigehiro Kadota, Machida-shi (JP); Noriaki Sato, Yokohama-shi (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/275,349

(22) Filed: Dec. 28, 2005

(30) Foreign Application Priority Data
Jan. 6, 2005 (JP) 2005-001528

(51) Int. Cl. G06F 9/00

(52) U.S. Cl. 715/750; 715/796; 715/790; 715/797

(57) ABSTRACT

To easily and optimally display data output from plural connected information terminals on a display device based on display attribute information given with respect to each output data, an information processing device, which calculates similarity of different image data and can connect the different image data to one display device and two or more information terminals, is characterized by comprising a data acquisition unit to acquire the data output from the information terminal, a display attribute information acquisition unit to acquire the display attribute information corresponding to the output data acquired by the data acquisition unit, an update unit to update the display attribute information acquired by the display attribute information acquisition unit, and a display control unit to control the display of the output data on the display device based on the relevant display attribute information.

### BACKGROUND OF THE INVENTION

1. Field of the Invention

The present invention relates to an information processing technique for executing display control of the data to be output to a display device.

2. Related Background Art

There is an electronic conferencing system as one of the conference forms which are spreading in recent years. Here, in the electronic conferencing system, in particular, various kinds of large-scaled display devices such as a plasma display, a rear projection display, a front projector and the like are used as a shared display device. In the electronic conferencing system like this, in general, a PC (personal computer) acting as an input/operation terminal is connected to the shared display device, whereby plural convocators (i.e., participants in the relevant electronic conference) share the information.

Moreover, since the electronic conferencing system in which the shared display device such as an electronic whiteboard is equipped with an information processing device can be operated simultaneously from plural information terminals connected, there is a method of exclusively controlling access to the shared display device by appropriately switching access authorities.

Moreover, Japanese Patent Application Laid-Open No. 2000-181846 (corresponding to U.S. Pat. No. 6,335,739) shows the method of avoiding the competition of accesses by setting access authority with respect to each window displayed on the screen of a shared device. In other words, in the shared display device, there are various proposals of controlling to display the plural information terminals and the plural windows.

However, in case of displaying the plural windows on the single screen, there is a problem that the plural windows mutually overlap. For this reason, every time the user executes the display operation for a different file, he/she has to adjust the size and display location of the window corresponding to the relevant file.

The above problem is the same as the technical problem in the general window system. That is, although it is possible to designate, as the setting of an arbitrary application, the specific window to be always displayed at the forefront, it is impossible to independently designate the display area with respect to each of the plural windows.

### SUMMARY OF THE INVENTION

The present invention has been completed in consideration of the above conventional problem, and an object thereof is to control the display state of the data to be displayed on the display screen of a shared display device so that a user can easily and clearly watch or see the displayed data even if the plural data output from plural terminals are competitive.

In order to attain the above object, the present invention is characterized by an information processing device which can be connected to one display device and two or more information terminals, the information processing device comprising:

a data acquisition unit adapted to acquire data output from a first information terminal or a second information terminal;

a display attribute information acquisition unit adapted to acquire display attribute information including display area designation information to be used in case of displaying the data acquired by the data acquisition unit on the display device;

a display control unit adapted to control the display of the data to be displayed on the display device, based on the display attribute information; and

an update unit adapted to, in a case where the output data which is output from the second information terminal and to which display area designation has been executed is present in an area which overlaps an area to which display area designation has been executed as a display attribute of the data which is output from the first information terminal, rewrite the display attribute information so as to display the data output from the first information terminal in a free area which does not overlap another area.

According to the present invention, it is possible to previously designate the display state of the output data from the information terminal on the screen of the display device.

Further, it is possible to display, even if the plural output data are competitive, the data so that one output data does not overlap other output data on the screen of the display device based on the display attribute information.

Furthermore, it is possible to display the output data from the high-priority information terminal on the forefront screen on the screen of the display device.

Moreover, it is possible to display the output data from the designated information terminal at the same location on the screen of the display device every time the relevant information terminal is connected, by setting the priority display area with respect to each information terminal.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate the embodiments of the present invention and, together with the description, serve to explain the principles of the present invention.

FIG. 1 is a block diagram showing the entire constitution of an electronic conferencing system which includes an information processing device according to each of the embodiments of the present invention;

FIG. 2 is a flow chart showing the procedure of the window display process to be executed in the information processing device according to each of the embodiments;

FIG. 3 is a flow chart for explaining the processing procedure by a display control means according to the first embodiment;

FIG. 4 is a flow chart for explaining the processing procedure by a display control means according to the second embodiment;

FIG. 5 is a flow chart for explaining the processing procedure by a display control means according to the third embodiment;

FIG. 6 is a flow chart for explaining the processing procedure by a display control means according to the fourth embodiment;

FIG. 7 is a diagram showing an example of the display window list of the information processing device according to each of the embodiments of the present invention;

FIG. 8 is a diagram showing an example of the operation for executing the display setting of the output data, in the information terminal according to each of the embodiments of the present invention;

FIG. 9 is a diagram showing an example of the setting of the display area in the information processing device according to each of the embodiments of the present invention and an example of the setting of the priority display area allocated to the information terminal;

FIG. 10 is a diagram showing an example of the priority display area table which is referred by the information processing device according to each of the embodiments of the present invention;

FIG. 11A is a conceptual diagram showing an example of the display screen of the display device according to the first embodiment;

FIG. 11B is another conceptual diagram showing an example of the display screen of the display device according to the first embodiment;

FIG. 12 is a conceptual diagram showing an example of the display screen of the display device according to the second embodiment;

FIG. 13 is a conceptual diagram showing an example of the display screen of the display device according to the third embodiment; and

FIG. 14 is a conceptual diagram showing an example of the display screen of the display device according to the fourth embodiment.

### DETAILED DESCRIPTION OF THE PREFERRED EMBODIMENTS

The preferred embodiments of the present invention will now be described in detail in accordance with the accompanying drawings.

### First Embodiment

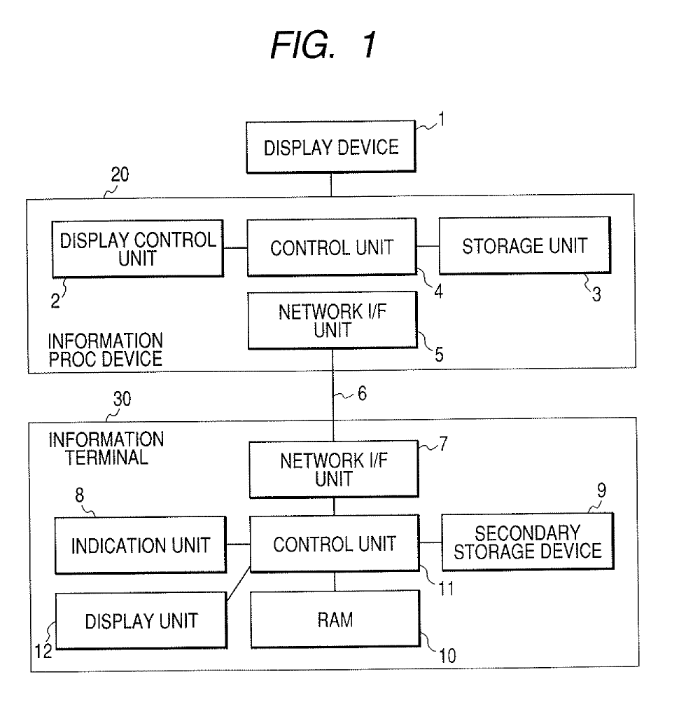

FIG. 1 is a block diagram showing the entire constitution of the electronic conferencing system which includes the information processing device according to each of the embodiments of the present invention.

In FIG. 1, a display device 1 is the shared display device which is used in the electronic conferencing system. More specifically, the display device 1 displays the output data from plural information terminals 30 which are connected to the display device 1 through the network such as a LAN (local area network) or the like.

Incidentally, the electronic conferencing system according to the present embodiment is constituted by an information processing device 20 which is connected to the display device 1, and the plural information terminals 30 such as a PDA (personal digital assistant), a note PC (personal computer) and the like which are connected to the information processing device 20 through a network 6 such as a LAN or the like.

The information processing device 20 consists of a display control unit 2 which controls the display area of the data to be output to the screen of the display device 1 in units of window, a storage unit 3 which stores the screen information, the CPU (central processing unit) and the RAM (random access memory) of a control unit 4 which controls each unit in the information processing device 20, and a network I/F (interface) unit 5 which controls the communication between the information processing device 20 and the information terminal 30.

Moreover, in the information processing device 20, the predetermined program has been stored in the ROM (read only memory) which functions as a part of the control unit 4, whereby the CPU of the control unit 4 reads the stored program and thus controls the operation according to the present embodiment.

Each of the information terminals 30 (also called the information terminal 30 hereinafter) consists of a network I/F unit 7 which controls the communication between the information terminal 30 and the information processing device 20, an indication unit 8 which consists of the pointing devices such as a mouse, a keyboard and the like for indicating the data output to the display device 1 through the information processing device 20, a secondary storage device 9 such as a hard disk drive or the like which stores the application programs and the program for indicating window display, a RAM 10 on which the read program is extracted, a control unit 11 which controls each unit in the information terminal 30 based on the extracted program, and a display unit 12 which displays application file data, the indication operation by the indication unit 8 and the processed results by the control unit 11.

Further, the network 6 is the network which connects the network I/F unit 5 of the information processing device 20 with the network I/F unit 7 of the information terminal 30. Incidentally, FIG. 1 shows only one information terminal 30 which is connected to the information processing device 20, as a matter of convenience. However, it is assumed that the plural information terminals 30 are actually connected to the information processing device 20.

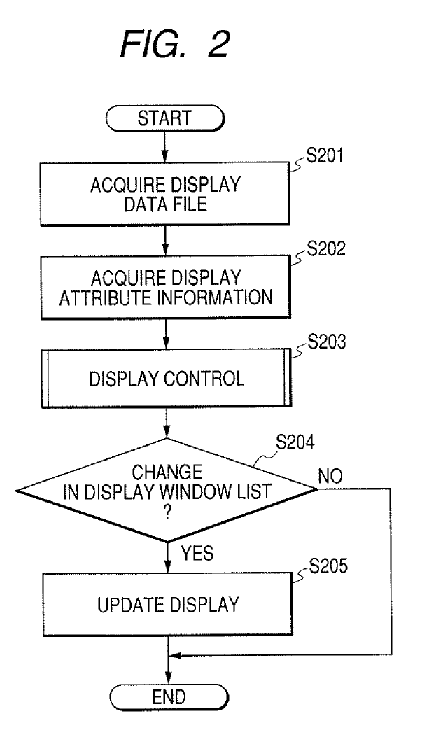

FIG. 2 is a flow chart showing the processing procedure to be executed when the information processing device 20 according to the present embodiment receives from the information terminal 30 the input signal indicating the data output to the display device 1.

In FIG. 2, after the information processing device 20 received the data output indication to the display device 1 from the information terminal 30 through the network I/F unit 7, in a step S201, the information processing device 20 acquires the data file indicated to be output to the display device 1. Then, in a step S202, the information processing device 20 acquires the display attribute information which is the display setting information in case of displaying the output-indicated data file on the display device 1.

Subsequently, in a step S203, if the display control means later described in FIG. 3 starts operating, the display control unit 2 updates the data of the storage unit 3 by checking the output data already window-displayed on the screen of the display device 1 and the display attribute information for window-displaying the newly output-indicated data.

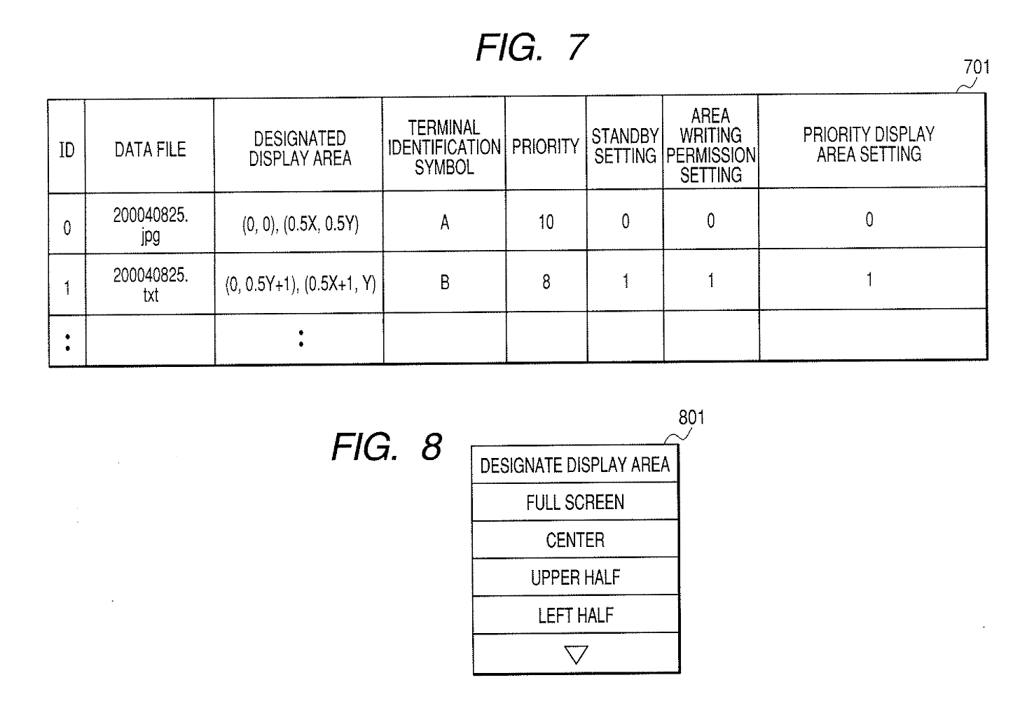

After then, if it is judged in a step S204 that a display window list 701 stored in the storage unit 3 is changed, the flow advances to a step S205 to update the display screen of the display device 1 by sending the signal from the display control unit 2. Here, the detail of the display window list 701 will be described later with reference to FIG. 7.

Meanwhile, if it is judged in the step S204 that the display window list 701 is not changed, the process ends as it is.

FIG. 3 is the flow chart for explaining the operation of the display control unit 2 in the information processing device 20, according to the present invention.

After the information processing device 20 received the output request from the information terminal 30, the control unit 4 of the information processing device 20 starts the operation of the display control means of the display control unit 2.

Subsequently, the case of executing the display to the designated display area indicated by the display attribute information will be explained with reference to FIG. 3.

In a step S301, the display control unit 2 judges whether or not the designated display area for window-displaying the output data to the display device 1 is a free area, by referring to the display attribute information acquired from the information terminal 30 and the display window list 701 of the storage unit 3. As a result, if it is judged that the designated display area of the acquired display attribute information is currently the free area in the display window list 701, the flow advances to a step S302 to add the information of the output data file acquired from the information terminal 30 and the display attribute information to the display window list 701.

Meanwhile, if it is judged in the step S301 that the designated display area is not the free area, that is, if another window has already been displayed in the designated area, the flow advances to a step S303 to transmit a display non-permission notification to the information terminal 30, and the process ends.

(Display Window List)

Subsequently, the display window list, on which the display attribute information of the output data is stored, to be referred to when the display control unit 2 executes the display control of the display device 1 will be explained. FIG. 7 shows the display window list which is displayed on the screen of the display device 1. Here, the window list is extracted from the display attribute information of the data output from the connected information terminals, stored in the storage unit 3 of the information processing device 20, and managed or controlled by the display control unit 2.

In FIG. 7, a display window list 701 includes the ID numbers corresponding to the respective windows displayed on the display device 1, the data of the data file of the output data displayed in the respective windows, and the following display attribute information.

That is, the display attribute information indicates the designated display areas for the respective windows, the symbols for discriminating the information terminals of outputting the data to the respective windows, the numeric values indicating the display priorities of the respective information terminals, presence/absence of the setting for being on standby until the area of one window which overlapped the area of another window becomes free, and presence/absence of the setting of the priority display area. Here, it should be noted that the value “0” indicates that the setting for being on standby is not present and also indicates that the setting of the priority display area is not present, and the value “1” indicates that the setting for being on standby is present and also indicates that the setting of the priority display area is present.

In addition, the display attribute information may indicate the designation of the length of the time of displaying each window, and the settings concerning the color, the brightness and the like of the respective windows.

Incidentally, as the method of executing the display setting constituting the display attribute information in the information terminal 30, the method of displaying the menu to cause a user to select appropriate items is shown in the present embodiment. However, the present invention is not limited to this. That is, it is also possible to independently provide the setting screen on which the user can execute the detailed settings with respect to the plural items.

Moreover, the display attribute information of the display window list is stored in the order of input to the information processing device. However, if the settings of the plural information terminals are competitive, the display control unit 2 can rewrite the data based on the display attribute information.

Incidentally, it is assumed that, in the display attribute information, the priority setting and the priority display area setting to be allocated to each terminal can be achieved by the user's operation on the side of the information processing device.

(Example of Display Attribute Information Setting in Information Terminal)

Next, the method of setting, in the information terminal, the display attribute of the data to be output to the display device 1 will be explained.

FIG. 8 is a diagram showing an example of the window, in the information terminal 30, which is the part of the operation screen on which the display setting is executed in case of window-displaying the attribute output data on the display device 1.

In FIG. 8, numeral 801 denotes a menu on which the display location in case of displaying the output data file on the screen of the display device 1 is designated. Here, it is assumed that the menu 801 is in the state that the user selects the arbitrary output data on the screen of the information terminal 30. Thus, the user can select the arbitrary item on the menu 801 by calling it with the input operation through the indication unit 8 of the information terminal 30. Incidentally, the display setting information which is set here is transmitted to the information processing device 20 as the part of the display attribute information.

Subsequently, the relation between the setting item of indicating the display location as the name and the display state in case of window-displaying the output data, in which the relevant name is used as the display attribute information, on the display device 1 will be explained.

That is, if “FULL SCREEN” is selected in the menu 801, the display setting for displaying the full screen on the display device 1 is executed. If “CENTER” is selected in the menu 801, the display setting for displaying the window so as to conform the center of the window to the center of the display device 1 is executed. If “UPPER HALF” is selected in the menu 801, the display setting for displaying the window at any location in the upper-half area on the screen of the display device 1 is executed. If “LEFT HALF” is selected in the menu 801, the display setting for displaying the window at any location in the left-half area on the screen of the display device 1 is executed. Likewise, it is also possible to set “LOWER HALF” and “RIGHT HALF”. In addition, more visceral names such as “UPPER”, “LOWER”, “LEFT” and “RIGHT” may be used to designate the location of the window.

At that time, it is also possible, by enabling to designate the display size of the window to be displayed on the display device 1, to execute the setting so as to change the display attribute information according to the display condition based on the combination of the display size and the display location. For example, if there is no designation, the size of the display window may be set variable as giving priority to the designated display location. On the other hand, the designated location may be set variable as giving priority to the size of the display window.

(Example of Display Area Setting in Display Device)

Subsequently, an example of enabling to set the display area by previously partitioning the display area into plural areas in the display device 1 will be explained.

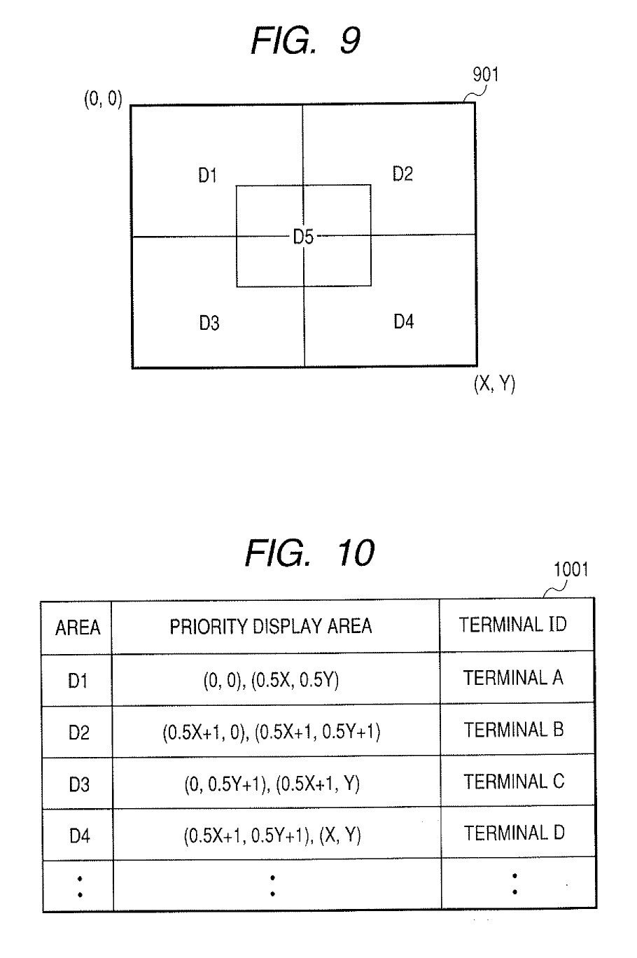

FIG. 9 is a diagram showing the example that the display screen of the display device 1 is previously partitioned into a finite number of areas, and the display control of the output data can be executed with respect to each partitioned area.

More specifically, in FIG. 9, five areas D1 to D5 are provided on a screen 901. Then, it is possible to prepare the menu including “UPPER LEFT”, “UPPER RIGHT”, “LOWER LEFT”, “LOWER RIGHT” and “CENTER” respectively corresponding to the areas D1 to D5 on the side of the information terminal 30 so as to cause the user to select the arbitrary area. That is, if the user on the side of the information terminal 30 sets the display location of the output data to “UPPER LEFT”, the relevant data output to the display device 1 is displayed in the area D1.

Subsequently, the process according to the present embodiment will be concretely explained with reference to the flow charts shown in FIGS. 2 and 3.

First, in the electronic conferencing system which includes the information processing device according to the present embodiment as illustrated in FIG. 1, the data output to the display device 1 is indicated by the information terminal 30 which is connected to the information processing device 20.

More specifically, the user of the information terminal 30 selects the arbitrary window displayed on the screen of the display unit 12 by using the pointing device of the indication unit 8, and executes the display setting in case of window-displaying the output data on the screen of the display device 1 through the menu as shown in FIG. 8. Thus, the data file and the display attribute information displayed in the window selected and indicated by the indication unit 8 are detected in the control unit 11 of the information terminal 30, and the detected data is transmitted from the network I/F unit 7 to the information processing device 20 through the network 6.

In the information processing device 20, if the network I/F unit 5 receives the signal transmitted from the information terminal 30, the process shown in FIG. 2 starts to first acquire the output data file to be displayed on the display device 1 (S201). Subsequently, the information processing device 20 acquires the display attribute information being the display setting information of the data file (S202), and then starts the display control means (S203).

If the control unit 4 causes the display control means to start its operation, the display control unit 2 first judges whether or not the designated display area for window-displaying the new output data on the display device 1 is the free area, by referring to the newly acquired display attribute information and the display window list 701 in the storage unit 3 (S301).

As a result, if it is judged that the designated display area is the free area, the newly acquired output data file and the display attribute information thereof are added to the display window list 701 in the storage unit 3, thereby updating the display window list. Thus, the control unit 11 judges that the display window list 701 is changed (S204), the display control unit 2 updates the display screen of the display device 1 based on the updated display window list (S205), and the output data designated at the information terminal 30 is window-displayed in the designated display area.

Meanwhile, if another output data has already been window-displayed in the designated display area indicated by the display attribute information of the newly output data, the display control unit 2 judges that the designated display area is not the free area (S301), whereby the data output indication received from the information terminal 30 is invalidated. In this case, a message of display non-permission notification generated by the control unit 11 is transmitted to the information terminal 30 from the network I/F unit 5 through the network 6 (S302).

(Explanation of Designated Display Area to be Displayed on Display Device)

Subsequently, the designated display area which is one of the display attribute information for displaying the output data from the information terminal 30 on the display device 1 will be explained.

Here, it should be noted that the designated display area is the area which is formed based on the coordinate data of the start point and the coordinate data of the end point for executing the window display on the screen of the display device 1. Further, it should be noted that to start and display the designated output data file within the rectangular area forming the diagonal line by the above two coordinates is called the window display.

Incidentally, it is possible to arbitrary set the designated display area for the window display. For example, if the area is set by such a name as shown in FIG. 8, the data is rewritten by the display control unit 2 of the information processing device 20 so as to conform it to the display device 1. Moreover, as shown in FIG. 9, it is possible to adopt the method of previously partitioning the display area of the display device 1 into the plural areas and then preparing the display setting menu corresponding to the partitioned areas on the side of the information terminal 30 to cause the user to select the arbitrary area.

Alternatively, it is possible to adopt the method of inputting the numeric values on the side of the information terminal 30 to designate the coordinate data corresponding to the screen of the display device 1.

Incidentally, the designation of the display area is mainly explained as the display attribute information. However, the present invention is not limited to this. That is, it is possible to enable to execute the settings concerning designation of a display time, color, brightness and the like, and the display control is executed based on these settings.

Moreover, the menu is displayed to cause the user to select the arbitrary items therefrom, as the display setting method in the information terminal 30. However, the present embodiment is not limited to this. That is, it is also possible to independently provide a setting screen so as to be able to execute on the setting screen the detailed settings to the plural items.

(State of Screen of Display Device Controlled by Display Control Unit)

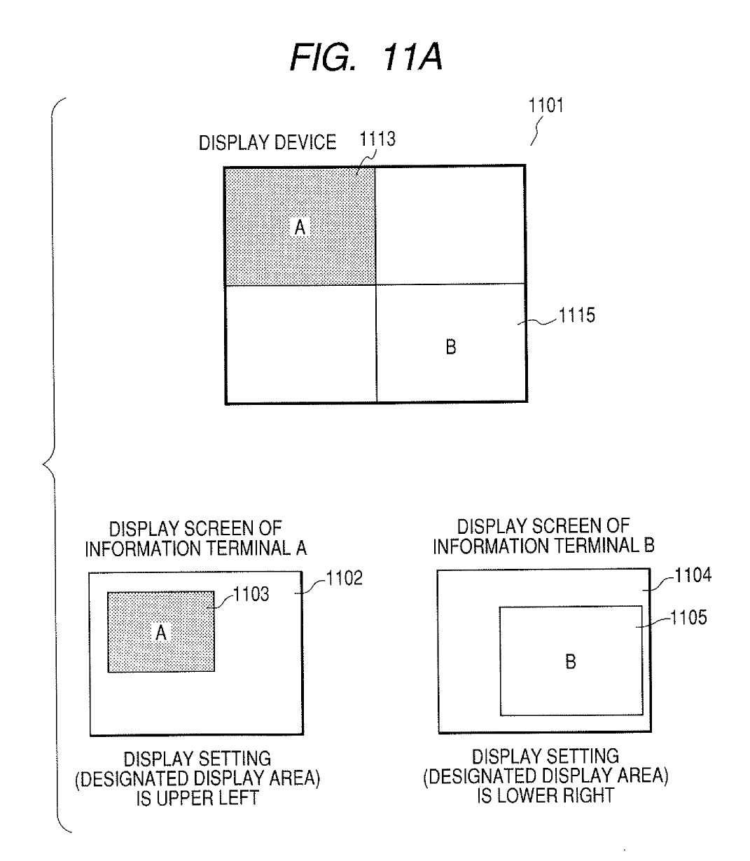

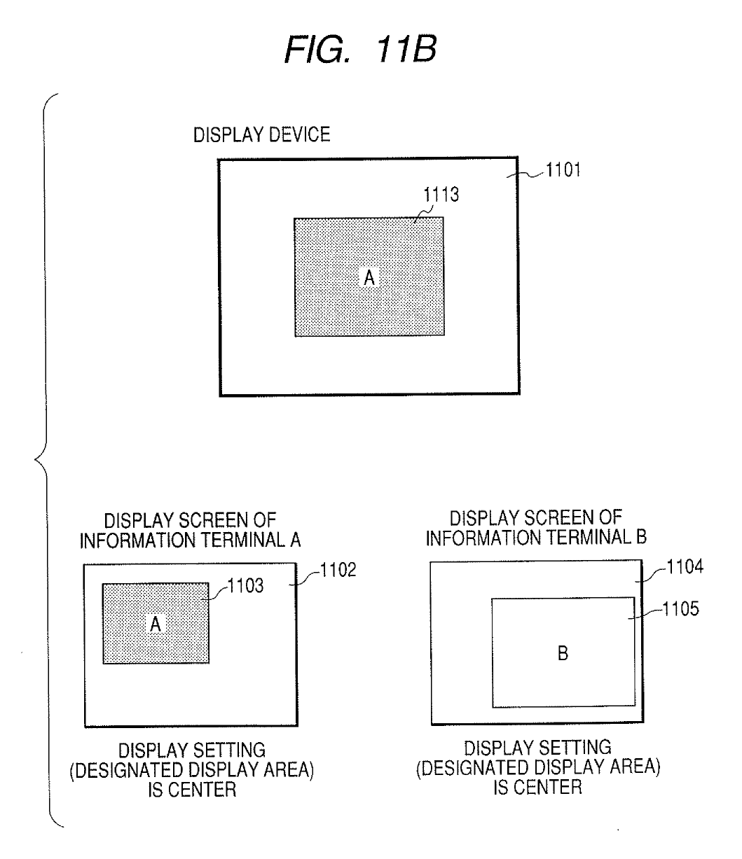

Although taking matters out of sequence, an example of the screen of the display device 1 to be displayed by the display control means according to the first embodiment explained in the flow chart of FIG. 3 will be explained with reference to FIGS. 11A and 11B.

FIG. 11A is the conceptual diagram showing the case of window-displaying the output data from the plural terminals on the display device 1, according to the present embodiment.

In FIG. 11A, numeral 1101 denotes the screen of the display device 1 which is connected to the plural information terminals 30 through the information processing device 20 and the networks. Numerals 1102 and 1104 respectively denote the display screens of the information terminals 30 which are connected to the information processing device 20. For the sake of convenience in the following explanation, it is assumed that the display screen 1102 corresponds to the information terminal A and the display screen 1104 corresponds to the information terminal B. Further, numeral 1103 denotes a window which is displayed on the screen of the information terminal A, and numeral 1105 denotes a window which is displayed on the screen of the information terminal B. That is, it is assumed that the user selects either the window 1103 or the window 1105 to indicate the output to the display device 1. Here, for the sake of convenience in the following explanation, it is assumed that the window selected and output-indicated by the user on the screen of the information terminal A is called the data A 1103 and the window selected and output-indicated by the user on the screen of the information terminal B is called the data B 1105.

Moreover, numerals 1113 and 1115 on the screen 1101 of the display device 1 respectively denote output data from the information terminals respectively connected to the information processing device 20. Here, the output data 1113 is also called the window A 1113 and the output data 1115 is also called the window B 1115. Moreover, it is assumed that the window A 1113 corresponds to the data A 1103 output-indicated by the information terminal A and the window B 1115 corresponds to the data B 1105 output-indicated by the information terminal B.

In the present embodiment, it is assumed that the data A 1103 is selected by the user on the screen 1102 of the information terminal A in the state of the data A 1103, and that the display setting is executed to display the data A 1103 at the upper left on the screen of the display device 1. Likewise, it is assumed that the data B 1105 is selected by the user on the screen 1104 of the information terminal B in the state of the data B 1105, and that the display setting is executed to display the data B 1105 at the lower right on the screen of the display device 1.

At that time, since the designated display area in case of displaying the data A 1103 on the screen 1101 of the display device 1 is different from the designated display area in case of displaying the data B 1105 on the screen 1101 of the display device 1, these data can be displayed in the respective designated display areas on the screen of the display device 1, such as the window A 1113 and the window B 1115.

Subsequently, the example of the screen of the display device 1 to be displayed by the display control means in a case where the designated display area of the data A 1103 output-indicated by the information terminal A and the designated display area of the data B 1104 output-indicated by the information terminal B overlap each other will be explained with reference to FIG. 11B.

Here, it is assumed that the output indication from the information terminal A is executed prior to the output indication from the information terminal B.

FIG. 11B is different from the FIG. 11A in the point of the state of the window displayed on the screen 1101 of the display device 1. That is, in FIG. 11B, the data B 1105 which is set to be displayed in the same designated display area as that for the data A 1103 as shown in FIG. 11A is not displayed on the screen 1101 of the display device 1.

However, at this time, if the standby setting as in the display window list 701 of FIG. 7 is set as the display attribute for the data B 1105, at the point when to output the data A 1103 ends, the data B 1105 is displayed as the window B in the area in which the window A 1113 was displayed up to then.

That is, as explained above, according to the first embodiment, on the display screen of the display device 1, the arbitrary output data file designated by the information terminal 30 can be displayed in the window display area based on the previously designated display setting.

Further, in case of newly displaying the output data on the display device 1, if the output data which has already been window-displayed in the previously designated display area is present, the new output data is not window-displayed. Therefore, there is an effect that the conference smoothly progresses without hiding or concealing the existing display state.

Moreover, since the standby setting can be executed for the display attribute information, even if the output data which has already been window-displayed is present in the previously designated display area, the new output data can be window-displayed in the relevant display area as well as the already window-displayed output data is gone.

### Second Embodiment

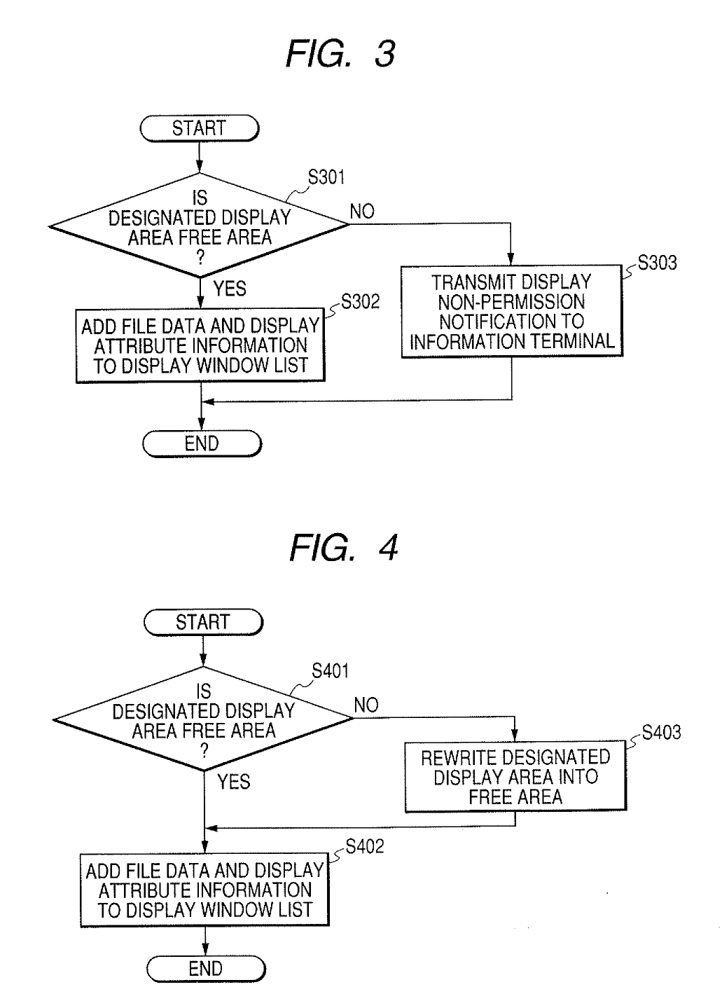

FIG. 4 is another flow chart for explaining the processing procedure to be executed by the display control unit 2 of the information processing device 20, according to the second embodiment of the present invention. In the present embodiment, a case where the plural output data are displayed without overlap will be explained.

After the information processing device 20 received the output request from the information terminal 30, the control unit 4 of the information processing device 20 starts the operation of the display control means of the display control unit 2.

In a step S401 of FIG. 4, the display control unit 2 judges whether or not the designated display area is a free area, by referring to the acquired display attribute information and the display window list 701 of the storage unit 3. Then, if it is judged that the designated display area is the free area, the flow advances to a step S402 to write the acquired file data and the display attribute information thereof to the display window list 701.

Meanwhile, if it is judged in the step S401 that the designated display area is not the free area, that is, if another window has already been displayed in the designated area, the flow advances to a step S403 to rewrite the coordinate data of the designated display area into the coordinate data of the free area. Then, the flow advances to the step S402 to add the acquired file data and the display attribute information thereof to the display window list 701, and the process ends. At that time, it should be noted that the coordinate data of the window display area in the display attribute information has been substituted by the coordinate data rewritten in the step S403.

Subsequently, the process according to the present embodiment will be concretely explained with reference to the flow charts shown in FIGS. 2 and 4. Here, it should be noted that the process up to the start of the display control means in the step S203 of FIG. 2 is substantially the same as that in the first embodiment, whereby the explanation thereof will be omitted.

If the control unit 4 causes the display control means to start its operation, the display control unit 2 first judges whether or not the designated display area for window-displaying the new output data on the display device 1 is the free area, by referring to the newly acquired display attribute information and the display window list 701 in the storage unit 3 (S401).

As a result, if it is judged that the designated display area is the free area, the file data acquired from the information terminal 30 and the display attribute information thereof are added to the display window list 701 in the storage unit 3 (S402), whereby it is judged that the display window list 701 has been changed (S204), the display control unit 2 updates the display screen of the display device 1 based on the updated display window list (S205), and the output data designated at the information terminal 30 is window-displayed in the designated display area.

Meanwhile, if another window has already been displayed in the designated display area on the screen of the display device 1 (S401), the flow advances to the step S403 to rewrite the newly acquired coordinate data of the designated display area into the coordinate data of the free area calculated by referring to the display window list 701 in the storage unit 3.

Then, the file data acquired from the information terminal 30 and the display attribute information thereof are added to the display window list 701 in the storage unit 3 (S402). At that time, it should be noted that the coordinate data of the designated display area for the window display in the display attribute information has been substituted by the coordinate data rewritten in the step S403. Thus, It is judged that the display window list 701 has been changed (S204), and the designated data file is window-displayed in the area different from the display area designated by the information terminal 30 on the display screen of the display device 1 display-updated (S205) by the display control unit 2.

In the present embodiment, the area in which the designated output data is window-displayed is randomly changed to the location where the window-display areas do not overlap, that is, to the free area on the screen of the display device 1. However, the present embodiment is not limited to this. That is, it is possible to display the window-display area at the location previously designated on the display device 1. For example, it is possible to set the window-display area to be located on the location shifted toward the X coordinate direction in the order of input of the new output data, or it is possible to set the window-display area to be located on the location shifted toward the Y coordinate.

(State of Screen of Display Device Controlled by Display Control Unit)

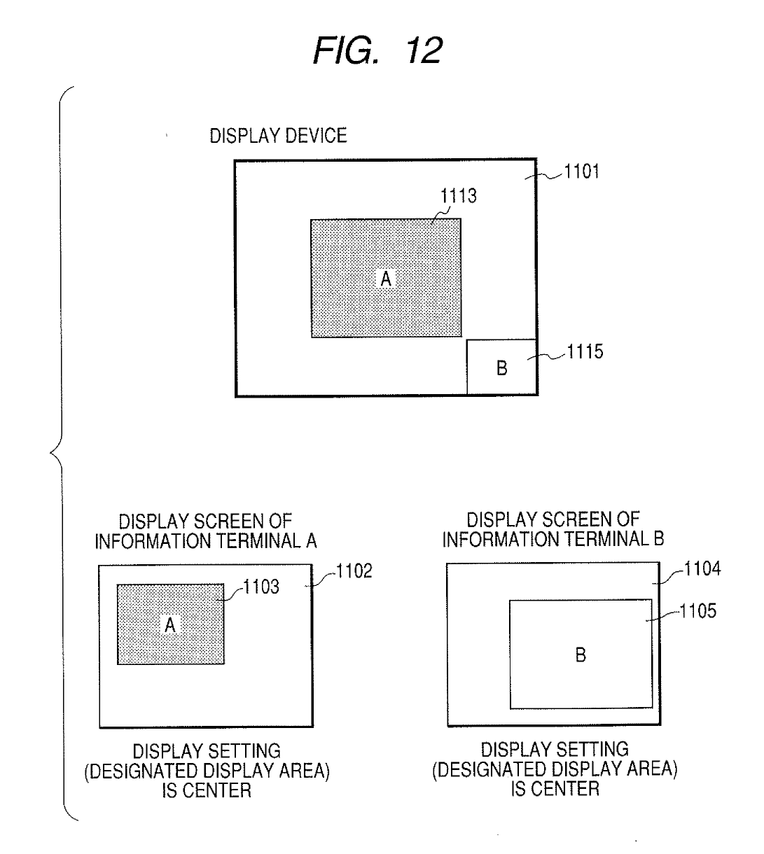

Although taking matters out of sequence, an example of the screen of the display device 1 to be displayed by the display control means according to the second embodiment explained in the flow chart of FIG. 4 will be explained with reference to FIG. 12.

FIG. 12 is the conceptual diagram showing the case of window-displaying the output data from the plural terminals on the display device 1 so that the displayed windows do not overlap, according to the present embodiment.

In FIG. 12, as well as FIG. 11B, it is assumed that the output indication has previously been executed from the information terminal A. However, FIG. 12 is different from FIG. 11B in that point that there is area rewriting permission setting as the display attribute information of the data B 1105. That is, if another window has already been displayed in the designated display area, it is possible to change the designated display area. As a result, the window B 1115 is displayed so that the data B 1105 is window-displayed in the free area on the screen 1101 of the display device 1.

As explained above, according to the second embodiment, in the case where the arbitrary output data file designated by the information terminal 30 is displayed in the previously designated window display area on the display screen of the display device 1, if the already displayed window is present in the relevant display area, then it is possible to display the designated output data file in the free area so that the display windows do not overlap each other. Thus, it is possible not only to display the plural windows so that these windows do not overlap but also to execute the window display of the new output data without affecting the existing display state of the display window 1.

Of course, in case of indicating the window display, it is possible to set to inhibit the display in the area other than the designated display area.

Moreover, it is possible to execute the display setting in the condition capable of changing the display setting based on the relative relation between the display window and another display window. More specifically, it is possible to execute the display setting according to the combination of the display window and its display size so as to satisfy the condition that the display window does not overlap another window even if the display size of the relevant window is small. Alternatively, it is possible to execute the display setting so as to satisfy the condition that the display size is fixed even if the relevant display window necessarily overlaps another window.

### Third Embodiment

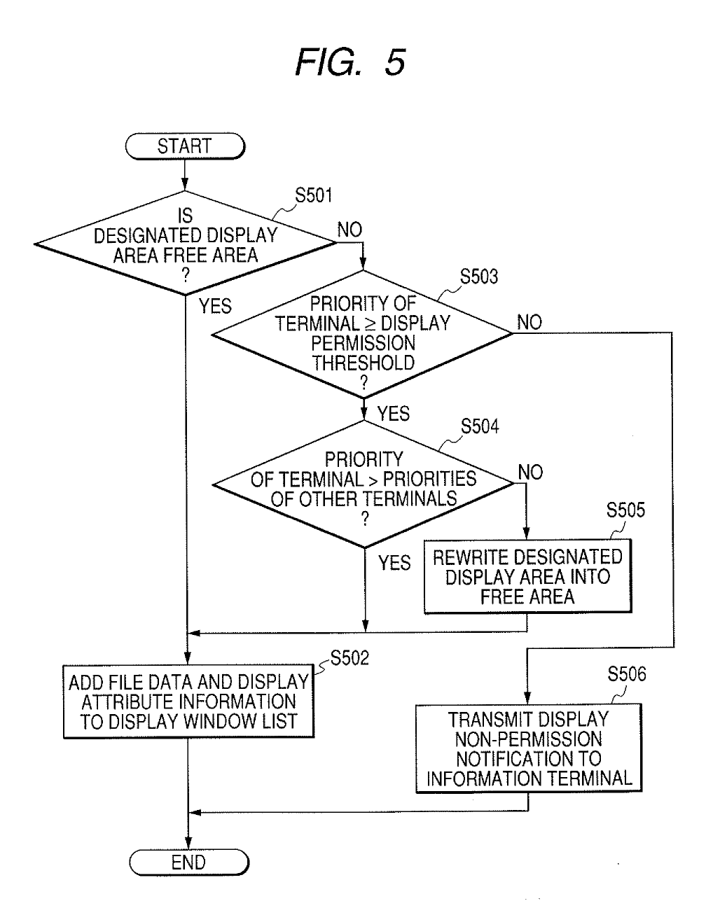

FIG. 5 is a still another flow chart for explaining the processing procedure to be executed by the display control unit 2 of the information processing device 20, according to the third embodiment of the present invention. In the present embodiment, a case where priority setting is present with respect to each information terminal as the display attribute information will be explained.

After the information processing device 20 received the output request from the information terminal 30, the control unit 4 starts the operation of the display control means of the display control unit 2.

In a step S501 of FIG. 5, the display control unit 2 judges whether or not the designated display area is a free area, by referring to the acquired display attribute information and the display window list 701. of the storage unit 3. Then, if it is judged that the designated display area is the free area, the flow advances to a step S502 to write the acquired file data and the display attribute information thereof to the display window list 701.

Meanwhile, if it is judged in the step S501 that the designated display area is not the free area, that is, if another window has already been displayed in the designated area, the flow advances to a step S503 to judge whether or not the priority of the information terminal 30 is equal to or higher than the display permission threshold which has already been determined by the information processing device. Here, if it is judged that the priority of the information terminal 30 is equal to or higher than the display permission threshold, the flow further advances to a step S504 to compare the priority of the information terminal 30 with the priority of another information terminal which is the owner of the currently displayed window. Then, if it is judged that the priority of the information terminal 30 is higher than the priority of another information terminal, the flow advances to the step S502 to add the acquired file data and the display attribute information thereof to the display window list 701, and the process ends.

Meanwhile, if it is judged in the step S504 that the priority of the information terminal 30 is lower than the priority of another information terminal, the flow advances to the step S505 to rewrite the coordinate data of the designated display area into the coordinate data of the free area. After then, the flow advances to the step S502 to add the acquired file data and the display attribute information thereof to the display window list 701, and the process ends. At that time, it should be noted that the coordinate data of the designated display area has been substituted by the coordinate data rewritten in the step S503.

Incidentally, if it is judged in the step S503 that the priority of the information terminal 30 is lower than the display permission threshold already determined by the information processing device, the flow advances to a step S506 to transmit a display non-permission notification to the information terminal 30, and then the process ends.

Subsequently, the process according to the present embodiment will be concretely explained with reference to the flow charts shown in FIGS. 2 and 5. Here, it should be noted that the process up to the start of the display control means in the step S203 of FIG. 2 is substantially the same as that in the first embodiment, whereby the explanation thereof will be omitted.

As shown in FIG. 5, if the control unit 4 causes the display control means to start its operation, the display control unit 2 first judges whether or not the designated display area for window-displaying the new output data on the display device 1 is the free area, by referring to the newly acquired display attribute information and the display window list 701 in the storage unit 3 (S501).

As a result, if it is judged that the designated display area is the free area, the acquired file data to be window-displayed and the display attribute information thereof are added to the display window list 701 in the storage unit 3 (S502), whereby it is judged that the display window list 701 has been changed (S204), the display control unit 2 updates the display screen of the display device 1 based on the updated display window list (S205), and the output data designated at the information terminal 30 is window-displayed in the designated display area.

Meanwhile, if another window has already been displayed in the designated display area on the screen of the display device 1 (S501), the flow advances to judge whether or not the priority of the information terminal 30 is equal to or higher than the display permission threshold based on the display permission threshold and the display attribute information of the information terminal 30 (S503).

Here, it is assumed that the already-determined display permission threshold has been stored in the storage unit 3 of the information processing terminal 20. As a result, if it is judged that the priority of the information terminal 30 is equal to or higher than the display permission threshold, the flow advances to compare the priority of the information terminal 30 with the priority of another information terminal which is the owner of the currently displayed window (S504).

Then, if it is judged that the priority of the information terminal 30 is higher than the priority of another information terminal, the flow advances to add the file data acquired from the information terminal 30 and the display attribute information thereof to the display window list 701 in the storage unit 3 (S502). Thus, the display control unit 2 judges that the display window list 701 has been changed (S204), and the designated data file is window-displayed in the display area designated by the information terminal 30 on the display screen of the display device 1 display-updated (S205) by the display control unit 2.

Incidentally, if it is judged that the priority of the information terminal 30 is lower than the display permission threshold (S504), the flow advances to rewrite the coordinate data of the designated display area acquired from the information terminal 30 into the coordinate data of the free area calculated by referring to the display window list 701 in the storage unit 3 (S505).

After then, the file data acquired from the information terminal 30 and the display attribute information thereof are added to the display window list 701 in the storage unit 3. At that time, it should be noted that the coordinate data of the window display area in the display attribute information has been substituted by the coordinate data rewritten in the step S505. Thus, the display control unit 2 judges that the display window list 701 has been changed (S204), and the designated data file is window-displayed in the area different from the display area designated by the information terminal 30 on the display screen of the display device 1 display-updated (S205) by the display control unit 2.

Incidentally, if it is judged that the priority of the information terminal 30 is lower than the display permission threshold (S503), the window display indication received from the information terminal 30 is invalidated. In this case, a message of display non-permission notification generated by the control unit 4 is transmitted from the network I/F unit 5 through the network 6 (S503).

In the present embodiment, after the display control means started its operation, it is first judged whether or not the designated display area is the free area, and it is then judged whether or not the priority of the information terminal is equal to or higher than the display permission threshold. However, the present invention is not limited to this. That is, it is possible to first judge whether or not the priority of the information terminal is equal to or higher than the display permission threshold, and then, if it is judged that the priority of the information terminal is lower than the display permission threshold, it is possible not to display the window even if the designated display area is the free area. This is effective for, for example, a mechanism of only displaying the data from the information terminals to which display permission is given.

(State of Screen Of Display Device Controlled by Display Control Unit)

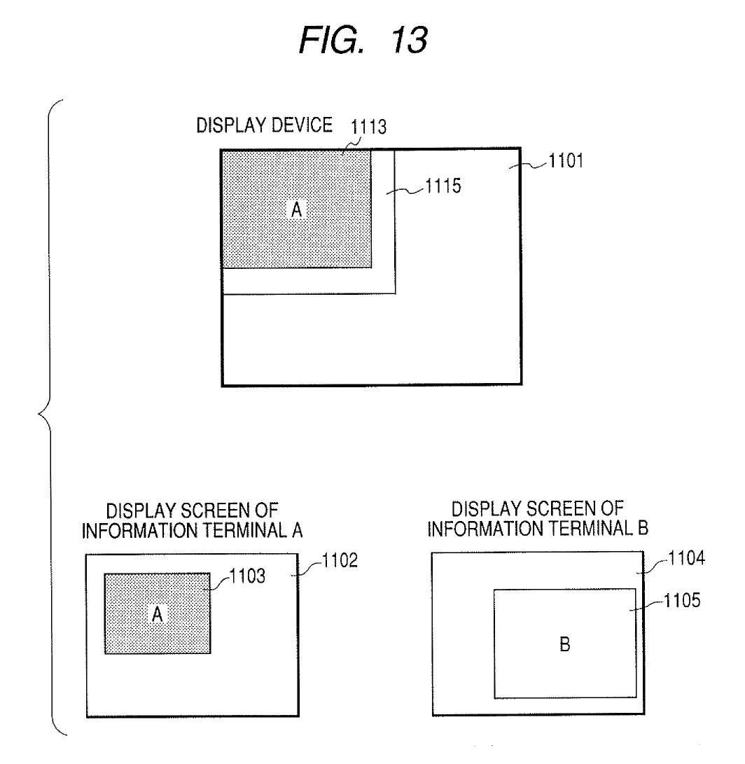

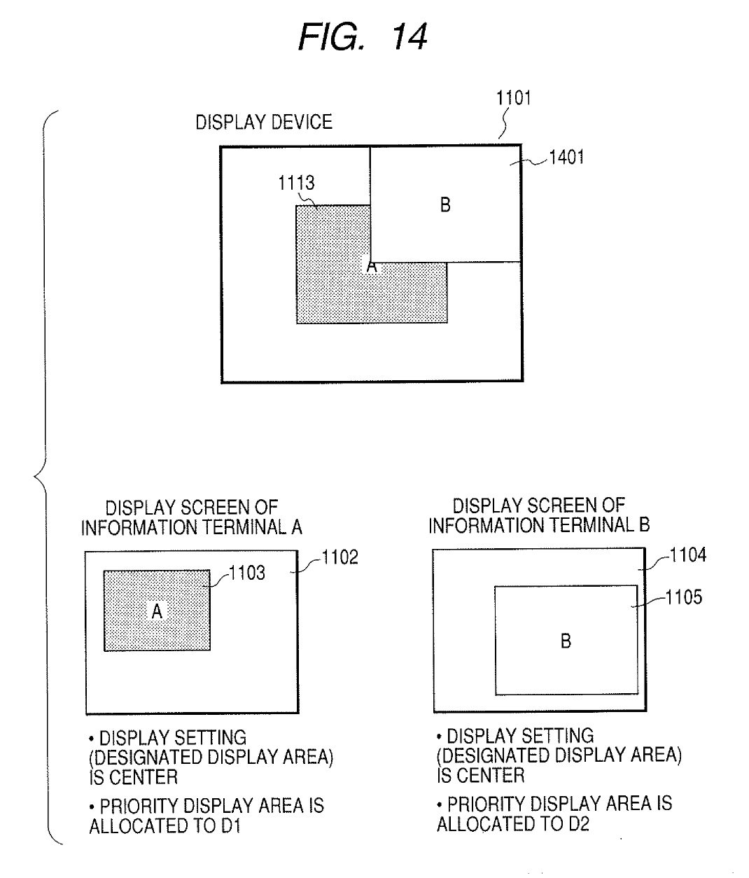

Although taking matters out of sequence, an example of the screen of the display device 1 to be displayed by the display control means according to the third embodiment explained in the flow chart of FIG. 5 will be explained with reference to FIG. 13.

FIG. 13 is the conceptual diagram showing that, in case of window-displaying the output data from the plural terminals on the display device 1, the display is changed based on the priorities of the information terminals when the designated display areas overlap each other, according to the present embodiment.

In FIG. 13, as well as FIG. 12, the output data sent from the information terminal A and window-displayed on the screen 1101 of the display device 1 is called the window A 1113, and the output data sent from the information terminal B and window-displayed on the screen 1101 of the display device 1 is called the window B 1115. Here, it is assumed that the output indication has previously been executed from the information terminal B. However, FIG. 13 is different from FIG. 12 in that point that the display is changed based on the priority of the information terminal which is included in the display attribute information as shown in the display window list of FIG. 7.

In the present embodiment, as the display attribute information of the output data, since the priority of the information terminal A is higher than the priority of the terminal B, the data A 1103 is preferentially displayed even if the data A 1103 overlaps the designated display area of the data B 1105 which has precedently output-indicated.

As a result, the window A 1113 is equivalent to that the data B 1105 is window-displayed on the screen 1101 of the display device 1, and is displayed on the window B 1115 of the data B 1105 output from the information terminal B.

Moreover, for example, it is possible to change the priority of the information terminal according to a time by properly combining the priority information and the time information. Thus, for example, the priority of the data output from the plural information terminals on the display device 1 can be properly changed according to the time schedule of a conference, the order of presentation, or the like, whereby there is the effect that the conference smoothly can progress.

### Fourth Embodiment

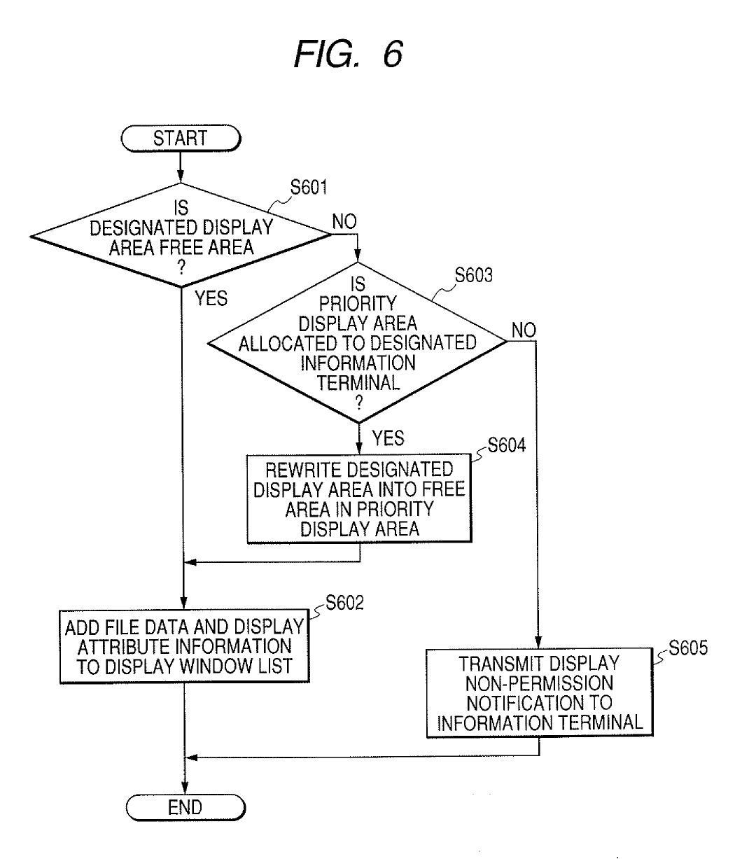

FIG. 6 is a still another flow chart for explaining the processing procedure to be executed by the display control unit 2 of the information processing device 20, according to the fourth embodiment of the present invention.

In the present embodiment, a case where setting of the priority display area is present with respect to each information terminal as the display attribute information will be explained with reference to the flow chart shown in FIG. 6.

After the information processing device 20 received the output request from the information terminal 30, the control unit 4 starts the operation of the display control means of the display control unit 2.

In a step S601 of FIG. 5, the display control unit 2 judges whether or not the designated display area is a free area, by referring to the acquired display attribute information and the display window list 701 of the storage unit 3. Then, if it is judged that the designated display area is the free area, the flow advances to a step S602 to write the acquired file data and the display attribute information thereof to the display window list 701.

Meanwhile, if it is judged in the step S601 that the designated display area is not the free area, that is, if another window has already been displayed in the designated area, the flow advances to a step S603 to judge whether or not the priority display area is allocated to the information terminal 30. Here, if it is judged that the priority display area is allocated to the information terminal 30, the flow further advances to a step S604 to rewrite the coordinate data of the designated display area into the coordinate data of the free area in the priority display area. Then, the flow advances to the step S602 to add the acquired file data and the display attribute information thereof to the display window list 701, and the process ends. At that time, it should be noted that the coordinate data of the window display area in the display attribute information has been substituted by the coordinate data rewritten in the step S604.

Incidentally, if it is judged in the step S603 that any display area is not allocated to the designated information terminal 30, the flow advances to a step S605 to transmit a display non-permission notification to the information terminal 30, and then the process ends.

Subsequently, the process according to the present embodiment will be concretely explained with reference to the flow charts shown in FIGS. 2 and 6. Here, it should be noted that the process up to the start of the display control means in the step S203 of FIG. 2 is substantially the same as that in the first embodiment, whereby the explanation thereof will be omitted.

If the control unit 4 causes the display control means to start its operation, the display control unit 2 first judges whether or not the designated display area for window-displaying the new output data on the display device 1 is the free area, by referring to the newly acquired display attribute information and the display window list 701 in the storage unit 3 (S601).

As a result, if it is judged that the designated display area is the free area, the acquired file data to be window-displayed and the display attribute information thereof are added to the display window list 701 in the storage unit 3 (S602), whereby it is judged that the display window list 701 has been changed (S204), the display control unit 2 updates the display screen of the display device 1 based on the updated display window list (S205), and the output data designated at the information terminal 30 is window-displayed in the designated display area.

Here, it is assumed that, in the information processing device 20, the setting for allocating the priority display area as shown in FIG. 10 is stored in the storage unit 3 with respect to the single or plural information terminals. In the present embodiment, to distinguish the respective information terminals 30, the information terminal 30 which is designated as follows is called the information terminal A.

If another window has already been displayed in the designated display area of the new output data which was designated to be window-displayed on the display device 1 (S601), it is judged whether or not the priority display area setting has been executed to the information terminal A, by referring to a priority display area table 1001 shown in FIG. 10 (S603).

As a result, if it is judged that the priority display area setting has been executed, the flow advances to acquire the priority display area information and then rewrite the designated display area information in the display attribute information of the new output data into the coordinate data of the free area in the priority display area (S604).

Then, the display control unit 2 adds the file data acquired from the information terminal A and the display attribute information thereof to the display window list 701 in the storage unit 3 (S602). At that time, it should be noted that the coordinate data of the window display area in the display attribute information has been substituted by the coordinate data of the new designated display area rewritten in the step S604.

Thus, it is judged that the display window list 701 has been changed (S204), the display control unit 2 updates the display screen of the display device based on the updated display window list (S205), and the designated data file is window-displayed in the free area within the allocated priority display area which is different from the designated display area of the information terminal A.

Incidentally, in the present embodiment, the display area to be changed in the case where another window is displayed in the designated display area is explained as the free area in the priority display area allocated to the information terminal. However, the present invention is not limited to this. That is, if there is no free area, it is possible, when the user indicates the window display, to select the setting for overlapping and displaying the data file in another window within the relevant priority display area.

On the other hand, if it is judged that the priority display area is not allocated to the information terminal 30 (S601) and the priority of the information terminal 30 is lower than the display permission threshold (S605), the window display indication received from the information terminal A is invalidated. In this case, a message of display non-permission notification generated by the control unit 4 is transmitted from the network I/F unit 5 to the information terminal 30 through the network 6 (S606).

In the present embodiment, in the case where there is no free area in the designated display area and the priority display area is not allocated, the window display indication for the new output data to the display device 1 is invalidated. However, the present is not limited to this. That is, if the free area capable of executing the window display is present, it is possible to execute the setting of changing the designated display area and then displaying the data file.

(State of Screen of Display Device Controlled by Display Control Unit)

Although taking matters out of sequence, an example of the screen of the display device 1 to be displayed by the display control means according to the fourth embodiment explained in the flow chart of FIG. 6 will be explained with reference to FIG. 14.

FIG. 14 is the conceptual diagram showing that, in case of window-displaying the output data from the plural terminals on the display device 1, the display is executed based on the priority display area set with respect to each information terminal, according to the present embodiment.

In FIG. 14, as well as FIG. 12, the output data sent from the information terminal A and window-displayed on the screen 1101 of the display device 1 is called the window A 1113, and the output data sent from the information terminal B and window-displayed on the screen 1101 of the display device 1 is called the window B 1115. Here, it is assumed that the output indication from the information terminal A is precedently executed. However, FIG. 14 is different from the previous embodiments in that point that the display is changed based on the display attribute information as shown in the priority display area table of FIG. 10.

At that time, although the designated display areas of the data A 1103 and the data B 1105 overlap each other and the priority of the information terminal A is higher than that of the information terminal B, the priority display area is set with respect to the information terminal B, whereby the window B 1401 is displayed above the window A 1113 as illustrated in FIG. 14.

Incidentally, as the premise of FIG. 10, it is explained in the present embodiment that the display area setting as shown in FIG. 9 has previously been executed with respect to the screen of the display device 1. However, the present invention is not limited to this.

As explained above, according to the fourth embodiment, in case of executing the window display on the display device 1, the priority display area is previously set with respect to each information terminal. Therefore, even if the output data from the plural terminals compete, the output data can appropriately be displayed preferentially in the designated display area. Moreover, even if the information terminal which was once disconnected is again connected, the output data can be appropriately window-displayed in the same designated display area as that at the previous connection time by the display priority area setting.

### OTHER EMBODIMENTS

Incidentally, the present invention is applicable to the system consisting of the plural devices (for example, a host computer, an interface equipment, a reader, a printer, and the like), or to the apparatus comprising the single device (for example, a copying machine, a facsimile machine, or the like).

Furthermore, it can be obviously understood that the object of the present invention can be achieved by supplying the storage medium storing therein the program codes of software to realize the functions of the above embodiments to a system or an apparatus, and thus causing the computer (or CPU, MPU) in the system or the apparatus to read and execute the program codes stored in the storage medium.

In this case, the program codes themselves read out of the storage medium realize the functions of the above embodiments. Therefore, the storage medium storing these program codes constitutes the present invention.

As the storage medium from which the program codes are supplied, for example, a Floppy™ disk, a hard disk, an optical disk, a magnetooptical disk, a CD-ROM, a CD-R, a magnetic tape, a nonvolatile memory card, a ROM or the like can be used.

Further, it can be obviously understood that the present invention includes not only a case where the functions of the above embodiments are realized by executing the program codes read by the computer, but also a case where the OS (operating system) or the like running on the computer executes a part or all of the actual processes based on the instructions of the program codes and thus the functions of the above embodiments are realized by the relevant processes.

Furthermore, it can be obviously understood that the present invention also includes a case where, after the program codes read out of the storage medium were written into the function expansion board inserted in the computer or the memory in the function expansion unit connected to the computer, the CPU or the like provided in the function expansion board or the function expansion unit executes a part or all of the actual processes based on the instructions of the program codes, and thus the functions of the above embodiments are realized by the relevant processes.

The present invention is not limited to the above embodiments, and various changes and modifications can be made within the spirit and scope of the present invention. Therefore, to apprise the public of the cope of the present invention, the following claims are made.

This application claims priority from Japanese Patent Application No. 2005-001528 filed on Jan. 6, 2005, which is hereby incorporated by reference herein.

What is claimed is:

1. An information processing device which can be connected to one display device and two or more information terminals, said information processing device comprising:
a data acquisition unit adapted to acquire data output from a first information terminal or a second information terminal;
a first display attribute information acquisition unit adapted to acquire display attribute information including display area designation information to be used in case of displaying the data acquired by said data acquisition unit on said display device;
a display control unit adapted to control the display of the data to be displayed on said display device, based on the display attribute information; and
a second update unit adapted to, in a case where the output data which is output from the second information terminal and to which display area designation has been executed is present in an area which overlaps an area to which display area designation has been executed as a display attribute of the data which is output from the first information terminal, rewrite the display attribute information so as to display the data output from the first information terminal in a free area which does not overlap another area.

2. An information processing device according to claim 1, further comprising:
a discrimination unit adapted to discriminate the plural information terminals;
a second display attribute information acquisition unit adapted to acquire display attribute information including priority setting allocated with respect to each information terminal, at a time when the data acquired by said data acquisition unit is displayed on said display device; and
a second update unit adapted to rewrite the display attribute information so as to display the data output from the first information terminal in an area which does not overlap a display area of precedently displayed output data in a case where the priority setting is not given as the display attribute of the data output from the first information terminal, and adapted to rewrite the display attribute information so as to display the data output from the first information terminal at a forefront in a case where the priority setting is given as the display attribute of the data output from the first information terminal.

3. An information processing device according to claim 1, further comprising:
a discrimination unit adapted to discriminate the plural information terminals;
a second display attribute information acquisition unit adapted to acquire display attribute information including priority display area setting allocated with respect to each information terminal, at a time when the data acquired by said data acquisition unit is displayed on said display device; and
a second update unit adapted to rewrite the display attribute information so as to always display the data output from the first information terminal in the priority display area in a case where the priority display area setting is given as the display attribute of the data output from the first information terminal.

4. An information processing device according to claim 1, further comprising:
a second display attribute information acquisition unit adapted to acquire display attribute information including setting of a length of a display time, at a time when the data acquired by said data acquisition unit is displayed on said display device; and
a second update unit adapted to rewrite the display attribute information so as to invalidate the display of the data if the set display time elapses, in a case where the setting of the length of the display time is given as the display attribute of the data output from the first information terminal.

5. An information processing device according to claim 1, further comprising a second display attribute information acquisition unit adapted to acquire display attribute information including setting of a color to be displayed, at a time when the data acquired by said data acquisition unit is displayed on said display device.

6. An information processing device which can be connected to one display device and two or more information terminals, said information processing device comprising:
a data acquisition unit adapted to acquire data output from a first information terminal or a second information terminal;
a first display attribute information acquisition unit adapted to acquire display attribute information including display area designation information to be used in case of displaying the data acquired by said data acquisition unit on said display device;
a display control unit adapted to control the display of the data to be displayed on said display device, based on the display attribute information; and
a first update unit adapted to, in a case where the output data which is output from the second information terminal and to which display area designation has been executed is present in an area which overlaps an area to which display area designation has been executed as a display attribute of the data which is output from the first information terminal, rewrite the display attribute information so as not to display the data output from the first information terminal.

7. An information processing device according to claim 6, further comprising:
a second display attribute information acquisition unit adapted to acquire display attribute information including setting of a length of a display time, at a time when the data acquired by said data acquisition unit is displayed on said display device; and
a second update unit adapted to rewrite the display attribute information so as to invalidate the display of the data if the set display time elapses, in a case where the setting of the length of the display time is given as the display attribute of the data output from the first information terminal.

8. An information processing device according to claim 6, further comprising a second display attribute information acquisition unit adapted to acquire display attribute information including setting of a color to be displayed, at a time when the data acquired by said data acquisition unit is displayed on said display device.

9. An information processing method for an information processing device which can be connected to one display device and two or more information terminals, said information processing method comprising:
a data acquisition step of acquiring data output from a first information terminal or a second information terminal;
a first display attribute information acquisition step of acquiring display attribute information including display area designation information to be used in case of displaying the data acquired in said data acquisition step on the display device;
a display control unit adapted to control the display of the data to be displayed on the display device, based on the display attribute information; and
a first update step of, in a case where the output data which is output from the second information terminal and to which display area designation has been executed is present in an area which overlaps an area to which display area designation has been executed as a display attribute of the data which is output from the first information terminal, rewriting the display attribute information so as to display the data output from the first information terminal in a free area which does not overlap another area.

10. An information processing method according to claim 9, further comprising:
a discrimination step of discriminating the plural information terminals;
a second display attribute information acquisition step of acquiring display attribute information including priority setting allocated with respect to each information terminal, at a time when the data acquired in said data acquisition step is displayed on the display device; and
a second update step of rewriting the display attribute information so as to display the data output from the first information terminal in an area which does not overlap a display area of precedently displayed output data in a case where the priority setting is not given as the display attribute of the data output from the first information terminal, and of rewriting the display attribute information so as to display the data output from the first information terminal at a forefront in a case where the priority setting is given as the display attribute of the data output from the first information terminal.

11. An information processing method according to claim 9, further comprising:
a discrimination step of discriminating the plural information terminals;
a second display attribute information acquisition step of acquiring display attribute information including priority display area setting allocated with respect to each information terminal, at a time when the data acquired in said data acquisition step is displayed on the display device; and
a second update step of rewriting the display attribute information so as to always display the data output from the first information terminal in the priority display area in a case where the priority display area setting is given as the display attribute of the data output from the first information terminal.

12. An information processing method according to claim 9, further comprising:
a second display attribute information acquisition step of acquiring display attribute information including setting of a length of a display time, at a time when the data acquired in said data acquisition step is displayed on the display device; and
a second update step of rewriting the display attribute information so as to invalidate the display of the data if the set display time elapses, in a case where the setting of the length of the display time is given as the display attribute of the data output from the first information terminal.

13. An information processing method according to claim 9, further comprising a second display attribute information acquisition step of acquiring display attribute information including setting of a color to be displayed, at a time when the data acquired in said data acquisition step is displayed on the display device.
